(19) United States
(12) Patent Application Publication
(10) Pub. No.: US 2013/0199285 A1
(43) Pub. Date: Aug. 8, 2013

(54) APPARATUS AND METHOD FOR TESTING ADHESION OF LAMINATED MATERIALS, SUCH AS LAMINATES HAVING A FOAM LAYER

(71) Applicants: Diane K. Murtonen, Ypsilanti, MI (US); Arthur Van Haselen, III, Phoenix, AZ (US); Francisco Vargas Alvarez, El Paso, TX (US)

(72) Inventors: Diane K. Murtonen, Ypsilanti, MI (US); Arthur Van Haselen, III, Phoenix, AZ (US); Francisco Vargas Alvarez, El Paso, TX (US)

(73) Assignee: FXI, Inc.

(21) Appl. No.: 13/367,931

(22) Filed: Feb. 7, 2012

(51) Int. Cl. G01N 19/04

(52) U.S. Cl. 73/150 R

(57) ABSTRACT

An apparatus and method for testing adhesion of a laminate, particularly a foam-film laminate, includes an inclined ramp to which the laminate is secured with an adhesive element and a weight that travels down the ramp and over the laminate and adhesive element. After the weight has been applied, the adhesive element is removed and the percentage separation of laminate layer(s) from the laminate surface is assessed. The weight may be a roller that is guided with a guide element along its path of travel.

### BACKGROUND OF THE INVENTION

1. Field of the Invention

The field of the present invention relates to apparatuses and methods for testing adhesion of laminated materials, particularly where a laminated material includes at least one foam layer.

2. Background

Polyurethane foam has a wide variety of applications, including cushioning materials, filtering materials, packaging materials and structural members. Sometimes vinyl film, polyethylene film, polyolefin film, other polymeric films and/or fabric layers are joined to foam surfaces by various techniques, such as adhesion or flame lamination, to create laminates. Some applications benefit from laminates having a generally smooth and continuous surface layer, with increased slip. Other applications benefit from having laminates with flame resistant surfaces. Regardless of the reason(s) for lamination, the quality of the adhesion of layers in a laminate material frequently must be assessed. Unfortunately, where one or more of the laminate layers is foam, few, if any, traditional methods of testing laminate adhesion are effective.

Traditional methods for testing the quality of adhesion of laminated materials, such as laminated plastic and metallic materials, often measure bond or peel strength of adhered layers by applying a tape to a scored surface and removing the tape. These methods are targeted toward laminate layers applied to substrates or intermediate layers without surface disruptions. The first step when using these methods often is to initiate layer separation using chemical or cutting techniques.

Unfortunately, these methods are typically not reproducible, especially where layers or substrates have surface discontinuities that vary in size and depth. In addition, these tests are known to be destructive to the cell structures of foams. Foam resiliency also can impact the depth of cut and the surface force for peel tests, leading to even greater difficulty in reproducing results of traditional adhesion tests. Moreover, where one or more thin laminate layers are used, e.g., layers with thicknesses of 10 μm or less, use of traditional methods is particularly difficult.

In consideration of the limitations of these and other adhesion testing methods, a clear need exists for improved apparatuses and methods of testing adhesion of laminated materials.

### SUMMARY OF THE INVENTION

An apparatus and method for testing adhesion of laminated materials includes a ramp having at least one inclined section onto which a laminated specimen is secured. A laminated specimen, such as a foam-film laminate, is prepared and coupled to the inclined section. An adhesive element, such as a strip of adhesive tape, is placed onto a surface layer of the laminated specimen. A weight is caused to travel down the inclined section and over the laminated specimen. The weight applies a reproducible force to the adhesive element and the laminated specimen to adhere more uniformly the adhesive element to the surface layer of the laminated specimen. When the adhesive element thereafter is removed, the specimen is checked for delamination.

### BRIEF DESCRIPTION OF THE DRAWINGS

The drawings described herein are for illustrative purposes only and are not intended to limit the scope of the present disclosure. In the drawings:

FIG. 1 is a right front perspective view of an apparatus for testing adhesion of laminated materials;

FIG. 2 is a top plan view of the apparatus shown in FIG. 1;

FIG. 3 is a side elevational view of the apparatus shown in FIG. 1; and

FIG. 4 is a sectional view of the apparatus shown in FIG. 1 taken along line 4-4 in FIG. 3, showing a path guide element configuration.

### DETAILED DESCRIPTION

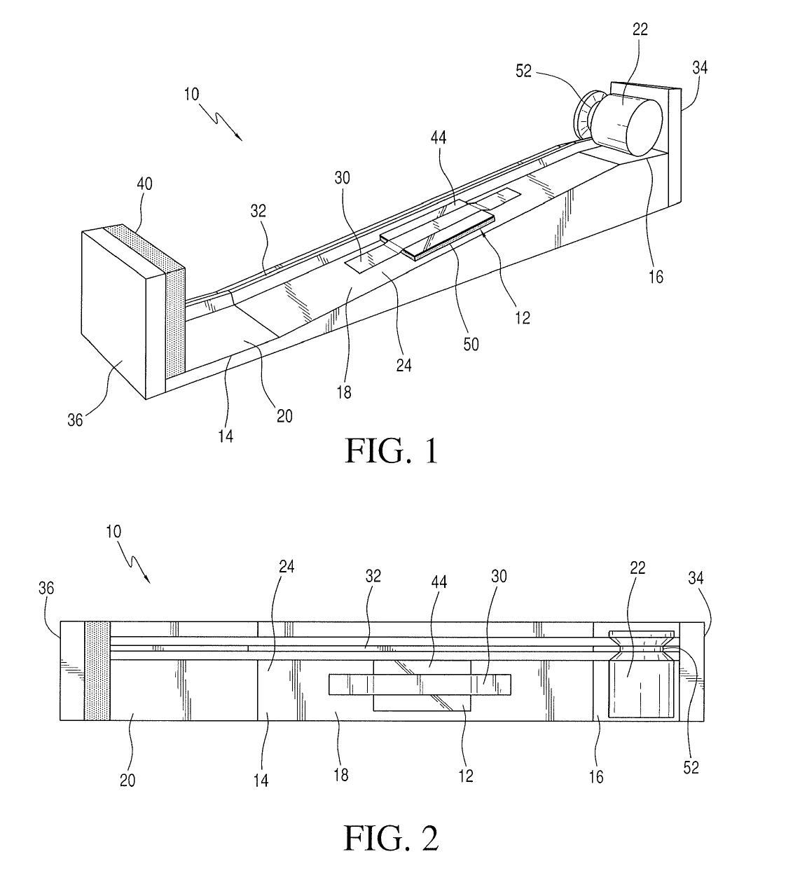

Turning in detail to the drawings, FIGS. 1-4 illustrate an apparatus 10 for testing adhesion of a laminated specimen 12. The apparatus 10 includes a ramp 14 having an upper section 16, at least one inclined section 18, and a lower section 20. The upper and lower sections 16, 20 are configured to seat a weight 22. The weight 22, as shown particularly in FIG. 1, is generally cylindrical and has a weight in the range of about 1.8 kg (3.9 lbf) to about 2.2 kg (4.9 lbf). Other weight ranges may be suitable, however, depending on various other factors, including the thickness of the laminated specimen, laminate material, and foam density.

Before testing, the laminated specimen 12 is positioned on the inclined section 18, and secured by an adhesive element 30 such as adhesive tape. The adhesive element 30 is placed over the specimen 12 and coupled to the ramp 14 in preparation for testing.

Together, the upper section 16, the inclined section 18, and the lower section 20 define a path of travel 24 for the weight 22. The weight 22 is positioned on the upper section 16 of the ramp 14 such that upon application of a force by a user or with a device, urging initial movement, the weight 22 travels along the path 24 and over the laminated specimen 12.

Upon removal of the adhesive element 30, the specimen 12 is inspected for signs of delamination. Delamination, as used herein, is defined as separation of one or more external laminate layer(s) from a substrate or intervening layer. Signs of delamination include peeling, bunching, exposure of interior layer surfaces or voids present in one or more laminate layers. These signs may be measured as a percentage of visible surface area of a layer of the laminated specimen. As an example, for a foam-film laminate, a percentage of exposed foam surface area may be calculated.

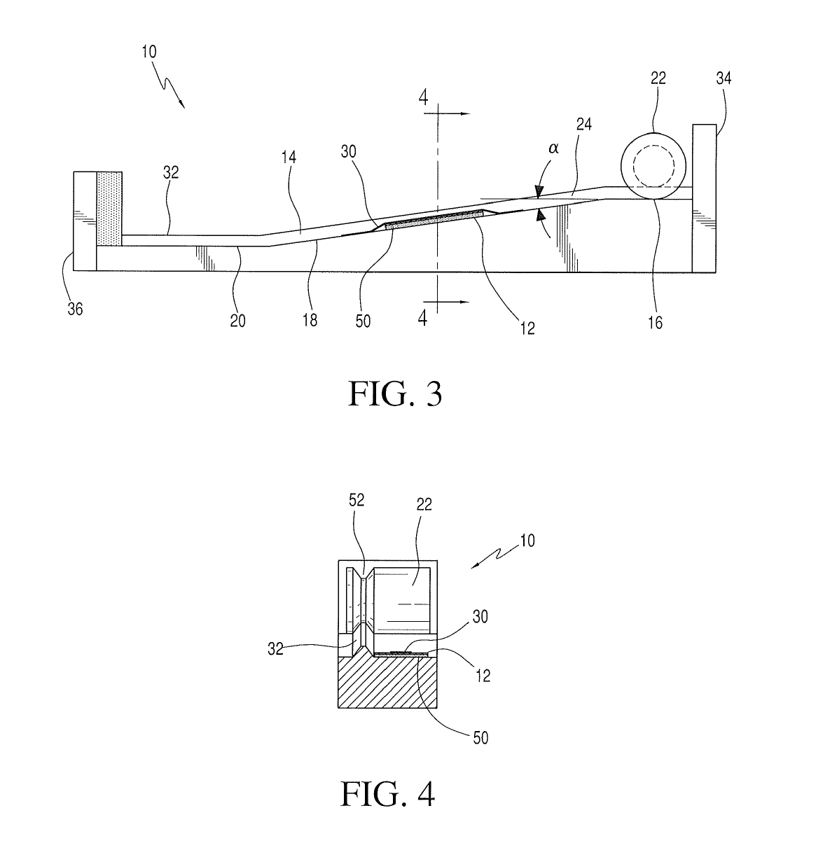

With respect to the upper section 16 which defines a first ramp height, the inclined section 18 is positioned at an angle α, as shown particularly in FIG. 3. The angle α preferably may range from about 5 to about 20 degrees. In one configuration, the inclined section 18 has an overall length of about 15 inches positioned at an angle α of about 8 degrees from the upper section. Optionally, the inclined section 18 may be provided with a surface that is convexly dished or has some other curvature to further facilitate travel of the weight. The inclined section 18 also may be provided with a recess (not shown) defined to at least partially contain the laminated specimen 12. Additional inclined sections (not shown) positioned at different angles with respect to the upper section 16 also may be provided.

The ramp 14 may further include a path guide element 32. The path guide element 32 extends along the path of travel 24 for the weight 22 defined by the upper section 16, the inclined section(s) 18, and the lower section 20. The path guide element 32 may be a raised surface, which is either coupled with or integral to the ramp 14. In one ramp 14 configuration, the path guide element 32 is integrated with the ramp 14. As shown particularly in FIG. 4, a path guide element 32 may be a raised rim having a generally truncated triangular cross-section. Alternatively, the path guide element 32 may be configured as a groove or recess (not shown) that extends fully or partially along the path of travel 24.

The path guide element 32 is adapted to mate with at least a portion of the weight 22 such that it guides the weight 22 during travel along the path of travel 24. In addition to or in lieu of the path guide element 32, side guide elements (not shown) may be positioned on one or both sides of the ramp 14. These side guide elements also may be used to guide the weight 22 during travel along the path 24.

Upright elements 34, 36 may also be included on the ramp 14. The upright elements 34, 36 are positioned on one or both ends of the ramp 14 in substantially vertical positions. These elements 34, 36 further may be coupled to the ramp 14, using any suitable method. Fastening elements (not shown) such as screws, however, are preferred. In the configuration shown, the first upright element 34 is coupled to the upper section 16 and the second upright element 36 is coupled to the lower section 20.

Positioned between the lower section 20 and the second upright element 36 is an impact absorbing member 40. This member is configured to stop travel of the weight 22 by deforming and absorbing energy upon impact. The impact absorbing member 40 may be manufactured from any type of material that absorbs impact energy, preferably by deformation. Suitable materials include sponge and foam materials, including polyurethane foams and more particularly viscoelastic foams. Other methods of slowing or stopping acceleration of the weight may also be used.

The ramp 14 is manufactured from any material suitable for forming the upper section 16 and one or more inclined sections 18. The ramp 14 may be manufactured from, for example, thermoplastic materials, having sufficient properties to support the weight 22 over long periods without significant deformation. Other types of materials, however, may be suitable. Such materials may include various types of metal, wood, and composite materials. In one configuration, the ramp 14 is manufactured from acetal homopolymer and polyoxymethylene (POM) sheet materials, having a typical tensile strength of about 10,000 psi, an impact strength of about 2.3 foot-pounds per inch and a Rockwell Hardness of 120 on an R scale. Suitable acetal homopolymer and POM materials include those manufactured by DuPont and sold under the name Delrin®.

While the apparatus and method herein may be used to assess bond strength of various laminated materials, the apparatus and method have particular advantage when used for laminates that include one or more resilient foam layers, such as foam-film laminates for automotive interiors or seating or for carpet cushions, and foam-fabric laminates for cushioning applications, such as furniture cushions. For example, a laminate may include a layer of polyurethane foam with a density in the range of about to 2.5 pounds per cubic foot and film, such as polyolefin, polypropylene, polyethylene, and/or vinyl, or a fabric, such as a woven, knit, nonwoven or other textile.

To prepare a laminated specimen 12 for testing, one or more laminated specimens are cut from predefined section of the laminated material (not shown). The laminated material may be a combination of layered materials, having at least one foam layer or substrate 50. Further, these materials may be provided in sheet or roll form. The overall thickness of the laminated material may range from about 3 millimeters to about 12 millimeters. In configurations having a foam layer or substrate 50, the thickness of the substrate 50 before application of the laminate layer 44 ranges from about 3 millimeters to about 6 millimeters. Preferably, foam substrates are manufactured from flexible polyurethane foams and coupled to relatively thin laminate layers. Preferred thicknesses of laminate layers range from about 2 μm (micrometers) to about 12 μm.

The specimen 12 may be sectioned from the laminated material 11 using any method that does not substantially affect properties of the laminated material 11. For example, the specimen 12 may be cut using a sharp edge to make the specimen any size or shape suitable for placement on the inclined section 18 or at least partially within a recess located on the inclined section 18. Rectangular shaped specimens, however, are preferred. The specimen 12 is substantially flat such that the weight 22 is not blocked during travel along the path 24. Further, the specimen 12 is placed onto the inclined section 18 such that a laminate layer 44 is on top, as shown particularly in FIGS. 1 and 2.

After placement of the laminated specimen 12, an adhesive element 30 is positioned over at least a portion of the laminate layer 44. The adhesive element 30 is preferably a tape material, having sufficient tack for adherence to the laminated specimen 12. Suitable adhesive elements 30 are manufactured by the 3M Corporation, including masking tapes sold under the Scotch® brandname.

Adhesives elements of this type are generally manufactured with a rubber-based adhesive and have the following typical properties: tensile strength of about 385 Newtons/100 millimeters (measured according to ASTM Method D-3759), elongation at break of about 9% (measured according to ASTM Method D-3759), and adhesion to steel strength of about 24 Newtons/100 millimeters (measured according to ASTM Method D-3330). While the overall thickness of the adhesive element may vary, thicknesses ranging from about 3 μm to about 5 μm are preferred.

During testing, the adhesive element 30 is positioned lengthwise along the specimen 12 and coupled to the ramp 14, as shown in FIGS. 1-3. Significant pressure is not applied to the specimen during this initial placement. During this step, placement is such that adhesive on the adhesive element lightly adheres to the laminate layer 44.

After positioning of the adhesive element 30 onto the laminated specimen 12, the weight 22 is positioned on the upper section 16 of the ramp 14. The weight 22 is such that significant deformation of the foam layer does not occur when the weight 22 is rolled over the specimen 12. Where the foam layer thickness is about 3 millimeters to about 6 millimeters, the weight 22 is specified at about 2 kg (kilograms). The weight 22 also preferably has a section or groove suitable for coupling with the path guide element 32. One type of weight 22 suitable for use with this method of testing is a CYL 2 kg NIST, Class F weight, having a cylindrical, bell-like shape. When this type of weight 22 is used, its neck portion 52 is positioned over the path guide element 32.

After the aforementioned steps, the adhesive element 30 is removed from the laminated specimen 12. A sight test is used to assess whether there is delamination of a laminate layer 44. For some applications, any visual delamination is not acceptable.

### EXAMPLES

Laminated materials having a foam substrate and a polyolefin top layer were tested, using the method and apparatus described above. For this test, polyethylene film, having an average thickness of 5 μm was laminated to a flexible foam substrate. The flexible foam substrate had an average density of 1.7 pounds per cubic foot (lb/ft³) and an average thickness of 3 millimeters. Flexible foams substrate of this type have an Indentation Force Deflection (4 inch sample 25%, minimum) of about 33 to about 43 and a Tensile Strength of about 12 pounds per square inch.

Using a heat process sometimes referred to as flame lamination, the surface of the film layer was softened such that it adhered to the foam substrate. Within one hour after processing the laminated materials, specimens were sectioned from the laminated material and prepared for testing.

For testing the specimen, a ramp, a CYL 2 kg NIST, Class F weight, and adhesive element sectioned from Scotch® Home and Office Masking Tape were used. The laminated specimen was placed onto the ramp and adhered to the inclined section. The weight was positioned to roll over the specimen along the path. Afterwards, the adhesive element was removed and the laminated specimen was inspected and visual signs of delamination (where the film layer separated from the foam) were assessed and measured.

After testing, the samples were visually inspected and a total surface area where delamination occurred was assessed. An adhesion parameter was then calculated as a percentage of delaminated surface area compared to laminated surface area. Generally, one or more areas of delamination are considered unacceptable. However, for certain applications a specific percentage may be deemed acceptable.

Earlier testing was conducted, using a scratch adhesion test originally developed for the paint industry by the American Society for Testing and Materials (“ASTM”)—ASTM D3359-09. This test method, however, yielded inconsistent results when used with foam substrates. It generally requires scoring the film layer, pressing a tape onto the scored area(s), and removing the tape from the film layer at a specified angle. Scoring of the film layer could not be accomplished without damaging the underlying foam matrix. As a result, removal of tape from a film layer resulted in delamination on all specimens.

Thus, an apparatus and method for testing adhesion of laminated materials, particularly those having at least one foam layer, is disclosed. While embodiments of this invention have been shown and described, it will be apparent to those skilled in the art that many more modifications are possible without departing from the inventive concepts herein. All examples presented are representative and non-limiting. The invention, therefore, is not to be restricted except in the spirit of the following claims.

What is claimed is:

1. An apparatus for testing adhesion of a laminate, comprising:
a weight; and
a ramp having at least one inclined section adapted for securing thereon a laminated specimen and defining a path of travel for the weight.

2. The apparatus of claim 1, wherein the ramp further comprises an upper section configured to seat the weight at a first ramp height.

3. The apparatus of claim 2, wherein the ramp further comprises a lower section configured to seat the weight at a second ramp height.

4. The apparatus of claim 1, wherein the ramp further comprises a guide element that extends along the path of travel.

5. The apparatus of claim 4, wherein the guide element extends to a height above the first ramp height in the upper section, and a height above the inclined section.

6. The apparatus of claim 2, further comprising a first upright section coupled to the upper section.

7. The apparatus of claim 3, further comprising an impact absorbing element coupled to the lower section.

8. The apparatus of claim 7, further comprising a second upright section coupled to the impact absorbing element.

9. The apparatus of claim 1, wherein the laminated specimen comprises foam.

10. The apparatus of claim 1, wherein the laminated specimen comprises polyolefin.

11. The apparatus of claim 1, wherein the laminated specimen comprises polyethylene film.

12. The apparatus of claim 1, wherein the weight is a roller.

13. A method for testing adhesion of a laminate, comprising:
securing a laminated specimen onto at least one inclined section of a ramp with an adhesive element that contacts a surface layer of the laminated specimen, said inclined section defining a path of travel for a weight;
causing the weight to move along the path of travel from a first ramp height to a second ramp height lower than the first ramp height and over the laminated specimen; and
removing the adhesive element from the laminated specimen.

14. The method for testing adhesion of a laminate of claim 13, further comprising:
measuring a surface area from which the surface layer of the laminated specimen has separated from other layer(s) forming the laminated specimen.

15. The method for testing adhesion of a laminate of claim 14, further comprising:
calculating adhesion as a percentage of surface area from which the surface layer of the laminated specimen has separated from other layer(s) forming the laminated specimen as compared to surface area of the laminated specimen.

16. The method for testing adhesion of a laminate of claim 13, wherein the laminated specimen comprises foam.

17. The method for testing adhesion of a laminate of claim 13, wherein the laminated specimen comprises polyolefin.

18. The method for testing adhesion of a laminate of claim 13, wherein the laminated specimen comprises polyethylene film.

19. The method for testing adhesion of a laminate of claim 13, wherein the weight is a roller that moves by rolling down the inclined section and over the laminated specimen.

20. The method for testing adhesion of a laminate of claim 13, wherein the ramp defines an upper section coupled to the inclined section and configured to seat the weight at the first ramp height.
